(19) United States
(12) Patent Application Publication
(10) Pub. No.: US 2007/0215821 A1
(43) Pub. Date: Sep. 20, 2007

(54) Shielded Irradiation Zone Of Production Line

(76) Inventors: Andrew J. Stirling, Kanata (CA); Gerald E. Hare, Nepean (CA)

Correspondence Address: MAINE & ASMUS, 100 MAIN STREET, P O BOX 3445, NASHUA, NH, 03061-3445, US

(21) Appl. No.: 10/555,210

(22) PCT Filed: Apr. 30, 2004
(86) PCT No.: PCT/CA04/00665

§ 371 Date: Feb. 5, 2007

Related U.S. Application Data
(60) Provisional application No. 60/466,730, filed on May 1, 2003.

(51) Int. Cl. G21F 1/00

(52) U.S. Cl. 250/515.1

(57) ABSTRACT

A shielding apparatus for an irradiator having an enclosed irradiation zone comprises conveying means adapted to convey carts carrying products for irradiation through an entry port into a shielded first tunnel section extending in a substantially straight path to the irradiation zone, and thence through a shielded second tunnel section extending in a substantially straight path from the irradiation zone to an exit port. The tunnel sections have a substantially identical vertical cross-section which is uniform along their lengths, and each cart has end walls comprising an irradiation shield means configured for a clearance fit with the uniform cross-section of the tunnel sections. Each tunnel section has at least one displacement zone, adapted to reduce radiation leakage from the irradiation zone towards the entry and exit ports. For each displacement zone a substantially horizontal first displacement is less than a maximum cross-sectional width of the tunnel section, a substantially vertical second displacement is less than a maximum cross-sectional height of the tunnel section and each displacement is greater than the corresponding clearance fit of the carts. A return section is provided for returning unloaded carts to a loading zone for reentry to the irradiation zone.

### FIELD OF THE INVENTION

The present invention relates to an irradiation apparatus, in particular an apparatus for conveying products into and out of an irradiation zone.

### BACKGROUND OF THE INVENTION

Irradiation systems are commonly used to sterilize medical and surgical equipment and supplies, food substances and other products. These products can be sterilized after being sealed in suitable packaging, and remain sterile until the package is opened by the end user; generally medical personnel in the case of medical and surgical uses, and the consumer in other cases. The process typically consists of loading items to be sterilized onto a suitable conveying means, passing the items into and out of a field of ionizing radiation, and subsequently removing the sterilized items from the conveying means. Such conveying means is typically a plurality of suitable containers carried on a conveyor belt system. Shielding to prevent the radiation from escaping from the radiation field must be provided, to prevent the serious risks of severe injuries, medical problems or death for personnel operating the apparatus, if not shielded.

To provide the necessary shielding, present systems for such irradiation processes include substantial primary shielding along the length of the entire system, generally together with secondary shielding to prevent escape of radiation at the entry and exit areas. Such secondary shielding is typically effected, with varying success, by conveyor systems relying on either one or more well-defined angles, generally of approximately 90°, or one or more substantial curves along the conveyor path, so that radiation travelling in a straight line along the path closest to the irradiation zone will not escape through the entry or exit.

For example, U.S. Pat. No. 6,294,791 to Williams et al illustrates an irradiation system where the conveyor traverses a serpentine path in plan view within heavy concrete walls to prevent the escape of radiation from the system. This design further requires that the floor and ceiling also be constructed of concrete. As the result of the materials used and the large size of the system, the construction is expensive, and requires very strong foundations to support the weight.

Similarly, U.S. Pat. No. 4,866,281 to Bosshard shows a system in which the product containers are rotated through a series of angles each approximately 90°. Again, this type of system is expensive to construct, and requires a large space and very strong supporting foundations.

In each of these types of system, in addition to the problems of size, weight and costs, a still further disadvantage results from the changes in direction within the enclosed regions, in that product containers can readily become stuck at various points, and because of the nature of the hazards and the complexity of the system, releasing a stuck container, particularly from within the shielded zone, is a complicated maneuver.

U.S. Pat. No. 6,191,424, to Stirling and Hare, teaches a substantially straight-through conveyor in which shielding is attached to both ends of carts on which the items to be irradiated are carried. The cross-section of the straight-through tunnel closely matches the shape of the shielding on the carts to minimize the escape of radiation via the tunnel. However, it has been found that even with tight machining tolerances, there will be some radiation leakage through the cracks between the outer edges of the cart ends and the inside wall of the main tunnel shield.

It has now been found that product carriage carts can be provided with suitable configurations of end shields to correspond with the cross-section of tunnels through which the carts are conveyed, and to provide a clearance fit between the outside dimensions of the end shields and the tunnel walls. It has further been found that if one or more relatively small displacements, both horizontal and vertical, only slightly greater than such clearance fit, are incorporated into the conveyor path before and after the irradiation zone, the escape of radiation through the entry and exit of the conveyor path can be substantially reduced or eliminated, thus avoiding the use of conventional serpentine or angular maze configurations for the conveyor path. The ingress conveyor path can be substantially straight from the entry to the irradiation zone. Similarly, the egress conveyor path can be substantially straight from the irradiation zone to the exit, and may, but need not, be substantially parallel to the ingress conveyor path, thus enabling a significant reduction in overall size of a system, without loss of throughput volume, and allowing for various options of overall configuration for the system.

It should be noted that in order to eliminate the disadvantages resulting from the exposure of drive elements to irradiation, it is preferable for all elements of the drive system for the conveyors to be located externally to the shielded portion of the conveyor path. It has been found that an effective horizontal displacement within the ingress and egress conveyor paths can be achieved without adverse effect on the operation of an external drive system, thus permitting the continued use of such preferred system.

It has further been found that a conveyor system as described above can be combined with suitable additional known conveying means to provide a connecting return path for the carts, to take them in sequence through an unloading zone, a reloading zone and back to the commencement of the conveying path.

### SUMMARY OF THE INVENTION

The present invention therefore seeks to provide a shielding apparatus for an irradiator having an enclosed irradiation zone, wherein

(i) a channel comprising conveying means and adapted to convey a plurality of carts each having a storage region for products for irradiation extends from an entry port to an exit port, and passes through the irradiation zone;

(ii) the channel includes a shielded first tunnel section extending in a substantially straight path from the entry port to the irradiation zone and a shielded second tunnel section extending in a substantially straight path from the irradiation zone to the exit port;

(iii) the first and second tunnel sections have a substantially identical cross-section which is uniform along their lengths;

(iv) each cart has outside each end of its storage region an irradiation shield means which is configured for a clearance fit with the uniform cross-section of each of the first and second tunnel sections;

(v) each of the first and second tunnel sections has at least one displacement zone, adapted to reduce radiation leakage from the irradiation zone towards at least one of the entry port and the exit port, wherein for each displacement zone

(a) a substantially horizontal first displacement is less than a maximum cross-sectional width of the tunnel section;

(b) a substantially vertical second displacement is less than a maximum cross-sectional height of the tunnel section; and

(c) each displacement is greater than the corresponding clearance fit of the carts.

The present invention therefore provides a system comprising a conveyor path, which passes successively through a first (entry) tunnel section, an irradiation zone, and a second (exit) tunnel section. The two tunnel sections comprise shielding, preferably mild steel or concrete, and preferably lined with a stainless steel floor, roof, and sides, which minimizes corrosion, and maintains good machining tolerances. The track and wall include gradual displacements in both the horizontal and vertical directions in each tunnel section, the displacements having a dimension which is greater than the dimension of a clearance fit between the end shields of the product conveying carts and the inner surface of the tunnel sections, and can be up to approximately one-quarter of the related tunnel height or width, while maintaining a substantially linear configuration for the two tunnel sections. To minimize the width of the system, the sections are preferably aligned with each other, so that the conveyor path is substantially straight through the first tunnel section, the irradiation zone, and the second tunnel section. However, to accommodate any specific requirements for a system, other configurations are possible. For example, to match the features of the equipment of the irradiation zone, the conveyor path through that zone can be at an angle to either the ingress conveyor path, the egress conveyor path, or both, and the egress conveyor path can be at any desired angle in relation to the ingress conveyor path, yet at the same time retaining the simplicity and accuracy of the linear drive system and the product tracking, and avoiding the engineering and size problems of going through a number of full 90 degree bends as in the maze layout of conventional systems.

In a preferred embodiment, the conveyor path comprises a combination of conventional conveyor system elements, with a drive system provided by known drive means, preferably at the ingress end of the conveyor path.

Further in a preferred embodiment, the product containers comprise movable carts, each of which has end-walls adapted to block radiation, and are configured with an outer perimeter which closely corresponds to the inner cross-sectional configuration of the two tunnel sections, so that the carts can pass through the tunnel sections with the required clearance fit. The carts are loaded with product for irradiation at a suitable location at the commencement of the conveyor path, and then carried along the conveyor path by known means, such as by tracking rails, with which runners and wheels on the carts interrelate. The carts are preferably designed to be aligned with each other in continued sequence with a minimum space between successive carts, and to be in continuous contact with each other as they travel through the tunnel sections and the irradiation zone, so that each cart is pushed through the system by successive carts, moving in response to the external drive means. Preferably, a braking means is provided at a suitable point beyond the exit from the second tunnel section.

After the carts leave the exit from the second tunnel section, they can be conveyed to an unloading point, and thence returned to the loading point at the commencement of the conveyor path by a suitable return conveying means, or can be removed from the path, e.g. for repair.

As each cart travels through the irradiation zone, the time during which its end-walls are under the irradiation beam is unproductive, and the useful throughput is reduced. To minimize this the drive speed of the conveyor can be increased for the intervals during which end-walls pass under the irradiation beam, by up to 20 times the normal speed setting. It has been found that the rigid nature of the carts allows this to be done accurately with a consequent reduction in wasted time of as much as 95%.

### BRIEF DESCRIPTION OF THE DRAWINGS

The present invention will now be described with reference to the drawings, in which

FIG. 1A is an isometric view of the system of a first embodiment of the invention;

FIG. 1B is an enlarged isometric view of the first drive means of the embodiment of FIG. 1A;

FIG. 2 is a partially cut-away isometric view of the embodiment of FIG. 1A;

FIG. 3 is a partially cut-away isometric view of the tunnel sections of the embodiment of FIG. 1A, showing the displacements, exaggerated for ease of understanding;

FIGS. 4A and 4B are isometric views of a cart for use with the invention, and the underside of the cart, respectively; and

FIG. 5 is a schematic plan view of the system of a second embodiment of the invention.

FIGS. 6A to 6G show available alternative cross-sectional configurations for the tunnel sections of the invention.

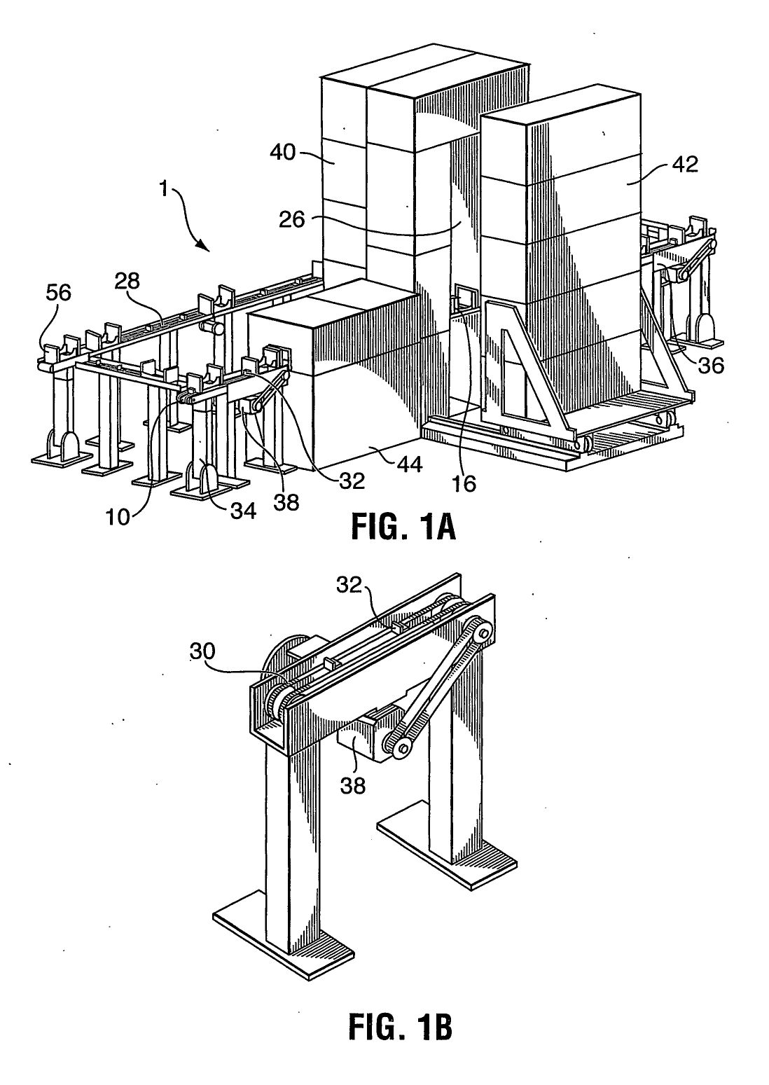

Referring to FIGS. 1A and 1B, a conveyor system 1 for irradiation of products comprises a continuous path, including a shielded irradiation zone 26, in which an irradiation zone shield 40 encloses suitable known irradiation equipment (not shown). The irradiation zone shield is provided with a retractable section 42, shown in FIG. 1A in its retracted position, to enable access to the irradiation zone 26 for maintenance or similar purposes.

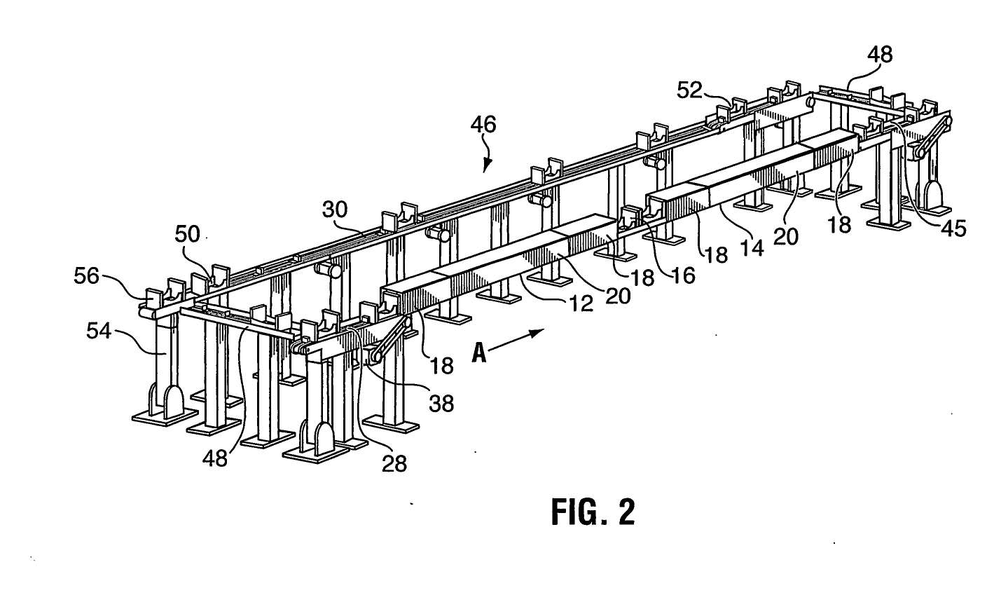

A conveying means 10, comprising a plurality of conveyors 28, and adapted to carry product carts 56, is suitably located to pass through irradiation zone 26, by means of an ingress first tunnel section 12 and an egress second tunnel section 14 (both shown in FIG. 2), contained within tunnel exterior shields 44. Between the first and second tunnel sections 12 and 14, an irradiation open zone 16 is provided.

The conveyors 28 are adapted to carry a plurality of carts 56 to convey product (not shown) to be irradiated through the system 1. In the embodiment shown in FIG. 1A, and as shown in greater detail in FIG. 1B, the conveyors are provided at the upstream end of each section with a drive means 38, and pusher bars 32 for directing the carts 56 forward along track 30. Each drive means can thus be located where it will not be exposed to the adverse effects of irradiation.

The conveying means 10 of this embodiment is provided with suitable known ancillary features, including side walls 36 and supports 34. In this embodiment the conveying means occupies a substantially horizontal plane, but variations can be effected for specific location requirements, for example by adjustment to the supports 34.

Further, the conveying means 10 can be provided with a suitable braking means (not shown) at braking zone 45 (shown in FIG. 2) downstream of the second tunnel exterior shield 44. Thereafter, the conveying means 10 passes to a return section 46, as discussed below.

Referring now to FIG. 2, the conveyor system 1 is shown with the irradiation zone shield 40 and the tunnel exterior shields 44 removed. Arrow A shows the direction of travel. A first tunnel section 12 comprises an ingress to the irradiation open zone 16, from which a second tunnel section 14 comprises an egress. Each of the tunnel sections 12 and 14 comprises a plurality of segments, in which at least one displacement segment 20 has a vertical and horizontal displacement in relation to a preceding and subsequent undisplaced segment 18. In this embodiment, each of tunnel sections 12 and 14 is provided with three segments, comprising one displacement segment 20 between two undisplaced segments 18.

The conveyor system 1 of this embodiment is substantially rectilinear. Thus, the conveying means 10 further includes two end conveyors 48 linked to the longer conveyors 28 by suitable rotation means such as turntables 54. At suitable locations, drive means 38 are provided to maintain the flow of carts 56 along the path of the conveyors 28 and 48. The conveyors 28 and 48 can be provided with pusher bars 32 (shown in FIGS. 1A and 1B). Included in the return section 46 is a product unloading zone 52 and a loading or reloading zone 50.

However, the return section 46 can be adapted to any desired configuration by the use of a suitable combination of conveyors 28, with changes of direction effected by known means, such as turntables 54, in a symmetrical or asymmetrical configuration, for example to meet the dimensions of the facility in which the system is to be installed. Additional features can also be added, such as a zone for removal of one or more carts 56, for example for repair, between the unloading zone 52 and the loading zone 50.

As discussed above, it is preferable in most installations for the conveyor system 1 to have a continuous path. However, the transfer of carts after unloading to the loading zone and thence back into the path of the conveying means 10 can be effected by any suitable means to provide for location conditions.

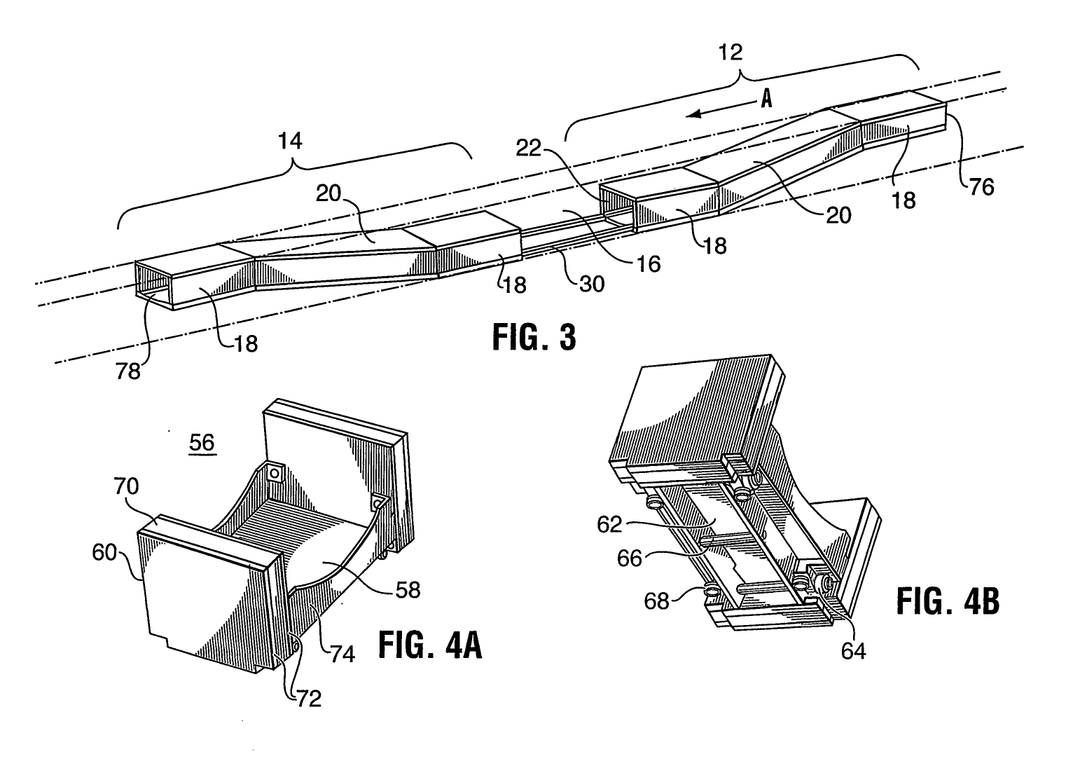

Referring to FIG. 3, the displacements of the tunnel sections 12 and 14 are shown, exaggerated for ease of understanding. The first tunnel section 12 comprises three segments as shown in FIG. 2, in which first and third undisplaced segments 18 are connected to each end of displacement segment 20, which is displaced in both a vertical and horizontal direction, shown here as being downwards and to the left, in relation to the general direction of travel shown by arrow A. Second tunnel section 14 has a similar configuration, except that the displacement segment 20 is displaced upwards and to the right, again in relation to the general direction of travel shown by arrow A. Between the two sections is the irradiation open zone 16. To correspond to the configuration of the carts 56 (discussed below in relation to FIGS. 4A and 4B), the tunnel sections 12 and 14 in this embodiment have a uniform vertical cross-section along their entire length, shown here as being substantially rectilinear. As discussed below, other configurations are possible, provided that the displacement is greater than the clearance fit. However, although the effective blocking of radiation can be achieved by a displacement substantially greater than the clearance fit, any displacement greater than approximately one-quarter of the corresponding tunnel width or height would result in a reduction of the advantages gained by the substantially linear aspect of each of the first and second tunnel sections 12 and 14.

The carts 56 on the track 30 of conveyor 28 are carried through entry port 76 into and through the first tunnel section 12, to the irradiation open zone 16 within irradiation zone 26 (see FIG. 1A), and through the second tunnel section 14 to the exit port 78.

Referring to FIGS. 4A and 4B, each cart 56 is provided with a product containment area, such as product platform 58, in which product to be irradiated (not shown) is placed, and retained therein by side walls 74 and shielded end walls 60. The side walls 74 can be of any suitable configuration, for example having the curved cut-away upper edge as shown in FIGS. 4A and 4B. The underside 62 of cart 56 is provided with suitable means for contact with, and secure carriage along the path of, the conveying means 10, such as wheels 64 and guide rollers 68, to retain the cart 56 on the track 30 (see FIG. 3). Further, rods 66 are adapted to connect with and be directed by the pusher bars 32 (shown in FIG. 1B) provided on the conveyors 28 and 48 (see FIG. 2). Each end wall 60 of the cart 56 comprises suitable shielding, shown here as lead inserts 70 between steel plates 72. The configuration for the end walls 60 is designed so that the rear end wall on one cart 56 will make maximum contact with the front wall on the next following cart 56. Preferably, the outer steel plate 72 is substantially planar and vertical when the cart 56 is in position on the track 30.

The perimeters of the end walls 60 of the carts 56 are configured to correspond to the configuration of the uniform cross-section of the inner surface 22 of the tunnel sections 12 and 14, so that the carts 56 can pass through the tunnel sections 12.and 14 with a clearance fit.

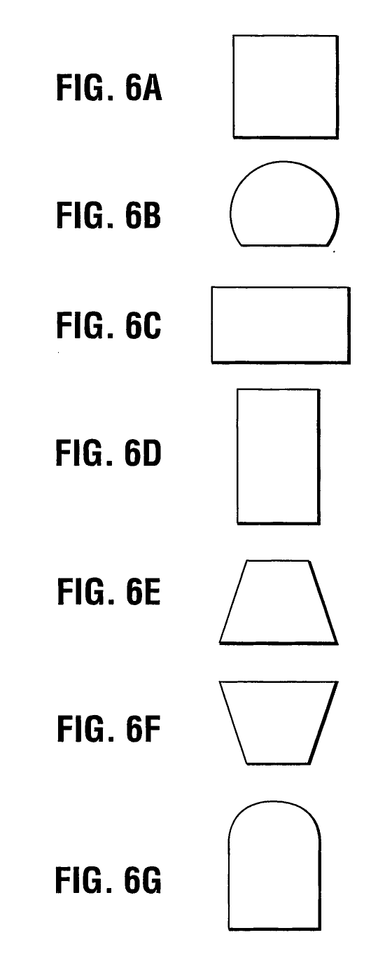

In addition to the rectilinear cross-sectional configurations shown in FIGS. 3, 4A and 4B, other configurations are possible for the tunnel sections 12 and 14, including but not restricted to the examples shown in FIGS. 6A to 6G. Such configurations need not be symmetrical about a vertical or horizontal axis, provided that the inner surface 22 of the tunnel sections in each case corresponds with the perimeter of the end walls 60 of the carts 56 in dimensions to provide the required clearance fit.

The displacements within displacement segments 20 of the tunnel sections 12 and 14 can be any dimension which is greater than the dimension of the clearance fit between the end walls 60 of the carts 56 and the inner surface 22 of the tunnel sections 12 and 14. The effect of the displacement is that in combination with the blocking effect of the carts 56, there is no straight line path for radiation from the irradiation zone 26 to pass through either of the tunnel sections 12 or 14 to the entry port 76 or the exit port 78, and thence to create a hazard to personnel near the irradiation system 1.

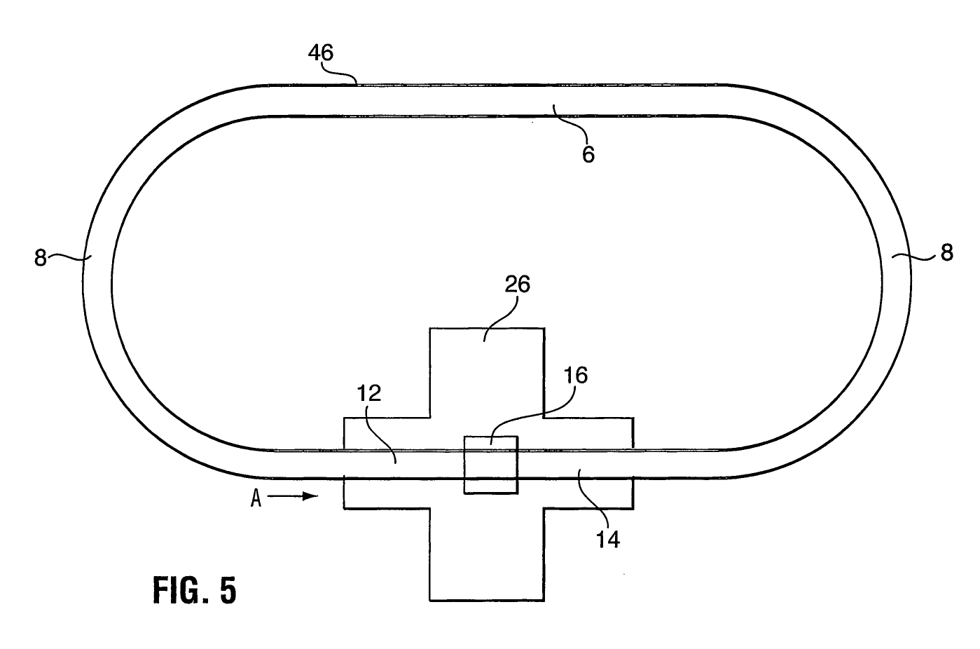

Referring to FIG. 5, an alternative embodiment of the conveyor system is shown schematically. In this embodiment, the tunnel sections 12 and 14 and the irradiation zone 26 are essentially unchanged from the embodiment of FIG. 1A. However, the path of the return section 46 of the conveying means 10 is shown as having a long return side 6 connected adjacent to the ingress and egress ends of the tunnel sections 12 and 14 respectively by substantially semicircular link sections 8. As discussed above, other configurations can be used to meet any specific requirements for the installation location.

In operation of the system, product to be irradiated is loaded onto carts 56. The loaded carts 56 are carried by the first conveyor 28 in the direction shown by arrow A in FIG. 1A into the entry port 76 of the first tunnel section 12. The effect of the drive means 38 provided upstream of the entry port 76, combined with braking at the braking zone 45 downstream of the exit port 78, is to ensure that adjacent carts 56 mutually push and restrain each other, so that no space develops between them during the carriage through the irradiation open zone 16 within the irradiation zone 26.

As the carts pass into the irradiation open section 16 of the irradiation zone 26, product irradiation time is lost during the intervals when end walls 60 of two adjacent carts 56 are passing through the irradiation open section 16. This time loss can be substantially reduced by providing for acceleration of the speed of the conveyor 28 at such intervals. If the operation of the system 1 is set such that there are always sufficient carts 56 on the first conveyor 28 to maintain close contact between them while passing through the irradiation open zone 16, the desired acceleration can be set accurately and effectively.

The exterior shielding 40 and 44 is constructed in a known manner with known materials, preferably of steel, concrete, lead or lead encased in steel. The tunnel sections 12 and 14 are similarly constructed, the inner surface 22 preferably being constructed of readily machinable materials which are resistant to ozone corrosion, such as stainless steel or ceramic. The end walls 60 of the carts 56 are similarly constructed of readily machinable materials resistant to ozone corrosion, preferably of lead encased in stainless steel.

1. A shielding apparatus for an irradiator having an enclosed irradiation zone, wherein
(i) a channel comprising conveying means and adapted to convey a plurality of carts each having a storage region for products for irradiation extends from an entry port to an exit port, and passes through the irradiation zone;
(ii) the channel includes a shielded first tunnel section extending in a substantially straight path from the entry port to the irradiation zone and a shielded second tunnel section extending in a substantially straight path from the irradiation zone to the exit port;
(iii) the first and second tunnel sections have a substantially identical vertical cross-section which is uniform along their lengths;
(iv) each cart has outside each end of its storage region an irradiation shield means which is configured for a clearance fit with the uniform cross-section of each of the first and second tunnel sections;
(v) each of the first and second tunnel sections has at least one displacement zone, adapted to reduce radiation leakage from the irradiation zone towards at least one of the entry port and the exit port, wherein for each displacement zone
(a) a substantially horizontal first displacement is less than a maximum cross-sectional width of the tunnel section;
(b) a substantially vertical second displacement is less than a maximum cross-sectional height of the tunnel section; and
(c) each displacement is greater than the corresponding clearance fit of the carts.

2. The shielding apparatus of claim 1, wherein the vertical cross-section of the first and second tunnels is substantially rectilinear.

3. The shielding apparatus of claim 1, wherein at least the upper portion of the vertical cross-section of the first and second tunnels is substantially arcuate.

4. The shielding apparatus of claim 2, wherein the first and second tunnels have vertical side walls.

5. The shielding apparatus of claim 1, wherein the first and second tunnels are substantially aligned in a horizontal plane.

6. The shielding apparatus of claim 1, wherein each of the first and second displacements is less than one-quarter of the corresponding width or height of the tunnel sections.

7. The shielding apparatus of claim 1 wherein the irradiation shield means at each end of each cart has a substantially planar outer surface adapted to make flush contact with substantially all of a corresponding planar outer surface of the irradiation shield means at an adjacent end of an adjacent cart.

8. The shielding apparatus of claim 1 wherein the conveying means comprises at least one conveyor driven by a drive means located upstream of the entry port.

9. The shielding apparatus of claim 8 wherein the conveying means further comprises a braking means located downstream of the exit port.

10. The shielding apparatus of claim 1 wherein the conveying means comprises a plurality of rails adapted to cooperate with wheel means on each cart.

11. The shielding apparatus of claim 1 wherein the conveying means comprises pusher bars adapted to engage and deliver a substantially horizontal propulsion force to a corresponding surface provided on each cart.

12. The shielding apparatus of in claim 1 wherein the conveying means comprises a plurality of conveyor sections.

13. The shielding apparatus of claim 12 wherein a conveyor section provided within the irradiation zone is provided with a speed regulation means adapted to provide for an increase in travel speeds of the conveyor whenever the irradiation shield means of a cart is in a target zone of an irradiation means.

14. The shielding apparatus of claim 12 wherein the conveying means comprises a return section adapted to return carts from an unloading zone downstream of the exit port to a loading zone upstream of the entry port.

15. The shielding apparatus of claim 11 wherein the conveying means comprises at least one accelerator means provided downstream of the exit port.

16. The shielding apparatus of claim 14 wherein the return section further comprises at least one turntable means.

17. The shielding apparatus of claim 1 wherein the tunnel sections comprise shielding constructed of machinable material resistant to ozone corrosion.

18. The shielding apparatus of claim 17, wherein the machinable material is selected from stainless steel and ceramic.

19. The shielding apparatus of claim 1, wherein the irradiation shield means provided to each end of each cart is constructed of lead encased in machinable metal resistant to ozone corrosion.

20. The shielding apparatus of claim 19, wherein the machinable metal is stainless steel.

21. The shielding apparatus of claim 1 wherein the vertical cross-section of the first and second tunnels is selected from substantially square, truncatedly circular, partially arcuate, rectangular and trapezoid.

22. A shielding apparatus for an irradiator having an enclosed irradiation zone, comprising:
(i) a channel comprising conveying means and adapted to convey a plurality of carts in sequence, each said cart having a storage region for products for irradiation, said channel extending from an entry port to an exit port, and passing through the irradiation zone;
(ii) said channel including a shielded first tunnel section extending in a substantially straight path from the entry port to the irradiation zone and a shielded second tunnel section extending in a substantially straight path from the irradiation zone to the exit port;
(iii) the first and second tunnel sections have substantially identical respective cross-sections which are uniform along their lengths;
(iv) each said cart has outside each end of its storage region an irradiation shield means configured for a clearance fit with the cross-sections of the tunnel sections;
(v) each of the tunnel sections has at least one displacement zone adapted to reduce radiation leakage from the irradiation zone towards at least one of the entry port and the exit port, wherein for each displacement zone
(a) a substantially horizontal first displacement is less than one quarter of the maximum cross-sectional width of the tunnel sections;
(b) a substantially vertical second displacement is less than one quarter of the maximum cross-sectional height of the tunnel sections; and
(c) each displacement is greater than the corresponding clearance fit of the carts; and
(vi) said conveying means comprises a speed regulation means adapted to provide for an increase in the travel speed of a said cart whenever the irradiation shield means of the said cart is in a target zone of said irradiation means.

23. A shielding apparatus for an irradiator having an enclosed irradiation zone, comprising:
(i) a channel comprising conveying means and adapted to convey a plurality of carts in sequence, each said cart having a storage region for products for irradiation, said channel extending from an entry port to an exit port, and passing through the irradiation zone;
(ii) said channel including a shielded first tunnel section extending in a substantially straight path from the entry port to the irradiation zone and a shielded second tunnel section extending in a substantially straight path from the irradiation zone to the exit port;
(iii) the first and second tunnel sections have substantially identical respective cross-sections which are uniform along their lengths;
(iv) each said cart has outside each end of its storage region an irradiation shield means configured for a clearance fit with the cross-sections of the tunnel sections and a substantially planar outer surface adapted to make flush contact with substantially all of a corresponding planar outer surface of the irradiation shield means at an adjacent end of an adjacent cart;
(v) each of the tunnel sections has at least one displacement zone adapted to reduce radiation leakage from the irradiation zone towards at least one of the entry port and the exit port, wherein for each displacement zone
(a) a substantially horizontal first displacement is less than the maximum cross-sectional width of the tunnel sections;
(b) a substantially vertical second displacement is less than the maximum cross-sectional height of the tunnel sections; and
(c) each displacement is greater than the corresponding clearance fit of the carts; and
(vi) said conveying means comprises a speed regulation means adapted to provide for an increase in the travel speed of a said cart whenever the irradiation shield means of the said cart is in a target zone of said irradiation means.
